(19) United States
(12) Patent Application Publication
(10) Pub. No.: US 2008/0261706 A1
(43) Pub. Date: Oct. 23, 2008

(54) Torsional vibration damper

(75) Inventors: Norbert Ament, Eltingshausen (DE); Reinhard Feldhaus, Euerbach (DE); Erwin Wack, Niederwerrn (DE); Michael Peterseim, Bergrheinfeld (DE); Alexander Markow, Schweinfurt (DE)

Correspondence Address: COHEN, PONTANI, LIEBERMAN & PAVANE LLP, 551 FIFTH AVENUE, SUITE 1210, NEW YORK, NY, 10176, US

(73) Assignee: ZF Friedrichshafen AG, Friedrichshafen (DE)

(21) Appl. No.: 12/148,428

(22) Filed: Apr. 18, 2008

(30) Foreign Application Priority Data
Apr. 20, 2007 (DE) 10 2007 018 654.3

(51) Int. Cl. F16F 15/139

(52) U.S. Cl. 464/98

(57) ABSTRACT

A torsional vibration damper includes a primary side having a pair of axially spaced cover disk elements which are fixed to each other, and a central disk element axially between the cover disk elements, wherein each disk element has a like plurality of circumferentially arranged openings, and each opening has a pair of circumferential support areas. A like plurality of damping element units are arranged in respective sets of openings, and are supported against the circumferential support areas. A radial support surface supports each damping element unit in a radially outward direction, each radial support surface extending without curvature in the axial direction.

### BACKGROUND OF THE INVENTION

1. Field of the Invention

The present invention pertains to a torsional vibration damper having a primary side and a secondary side which can rotate around an axis of rotation with respect to the primary side against the action of a damping element arrangement, wherein one of the two sides includes two cover disk elements arranged a certain distance apart and permanently connected to each other, and the other one of the two sides includes a central disk element which engages axially between the cover disk elements. The damping element arrangement has a plurality of damping element units arranged in a row around the circumference, and damping element openings provided in the cover disk elements and in the central disk element to hold these damping element units. The damping element units are supported against the circumferential support areas forming the essentially circumferential boundaries or the damping element openings, a radial support arrangement supports the damping element units of the damping element arrangement in the radially outward direction.

2. Description of the Related Art

FIGS. 1 and 2 show a torsional vibration damper of this type, which, in the actual application shown in FIG. 1, is incorporated into a hydrodynamic torque converter 10. This hydrodynamic torque converter is of conventional design and includes a housing 12, which is to be connected nonrotatably to a drive shaft. The housing 12 carries on its inner side a plurality of pump wheel vanes 14, which cooperate with the housing 12 to form a pump wheel 16. Inside the housing is a turbine wheel 18 with a plurality of turbine wheel vanes 20. A turbine wheel shell 22, which carries the turbine wheel vanes 20, is connected for rotation in common to a turbine wheel hub 25 by means of a torsional vibration damper arrangement 24, and is thus able to rotate with it around an axis of rotation A.

The torsional vibration damper arrangement 24 includes two radially offset torsional vibration dampers 26, 28. The radially inner torsional vibration damper 26 includes, as its primary side 30, two cover disk elements 32, 34, which are arranged a certain distance apart in the direction parallel to the axis of rotation. Radially on the inside, these disk elements are permanently connected to each other by a plurality of massive rivets 36, which are arranged a certain distance apart in the circumferential direction around the axis of rotation A; the disk elements are also permanently connected to the turbine wheel hub 22. The rivets 36 simultaneously act as spacers for the two cover disk elements 32, 34. A central disk element 40, providing the secondary side 38 of the radially inner torsional vibration damper 26, engages between the two cover disk elements 32, 34, as shown in somewhat greater detail in FIG. 2. This central disk element 40 has circumferential openings where the rivets 36 are located to allow relative rotation between the primary side 30 and the secondary side 38. Radially on the inside, as can be seen in FIG. 1, the central disk element 40 is permanently connected by rivets 42 to the pump wheel hub 26.

A damping element arrangement 44 of the radially inner torsional vibration damper 26 includes a plurality of damping element units 46, which are arranged in a row around the circumference and which are a certain circumferential distance apart. Each of these units can have, for example, a helical compression spring extending in the circumferential direction or possibly two helical compression springs, one inserted into the other. For each of the damping element units 46, the cover disk elements 32, 34 and the central disk element 40 have damping element openings 48, 50, 52 in the form of so-called “spring windows”. Each of these windows has boundaries in the circumferential direction formed by support areas 54, 56, 58. The damping element units 46 are supported in the circumferential direction against these support areas 54, 56, 58 and thus, as they are compressed, they allow the primary side 30 and the secondary side 38 to rotate relative to each other.

So that the damping element units 46 can also be supported radially on the outside and also in the axial direction, the cover disk elements 32, 34 have support areas 60, 62 radially on the outside where the damping element openings 48 and 50 are formed. These support areas are bent in the axial direction to form tab-like parts, which thus provide the individual support areas 64, 66. At least certain sections of these areas are designed to conform to the outside circumferential contour—in the present case, therefore, the circular contour—of the damping element units 46, which are thus supported radially on the outside and also in the axial direction and held securely in the damping element openings 48, 50.

Radially outside the damping element arrangement 44 and the central disk element 40, the two cover disk elements 32, 34 are permanently connected to each other by several rivets 68, which are distributed around the circumference, as indicated in FIG. 2 by the broken lines. As can be seen especially in FIG. 1, the cover disk elements 32, 34 extend radially beyond the rivets 68 and form there the secondary side 70 of the radially outer torsional vibration damper 28. A central disk element 72, situated between the two cover disk elements 32, 34 in their radially outer area, forms essentially the primary side 74 of this radially outer torsional vibration damper 28. Circumferentially between the rivets 68 which connect the two cover disk elements 32, 34, the central disk element 72 is permanently connected by rivets 76, which also pass through at least the cover disk element 32, to a connecting element 78 and thus to the inner plate carrier 80 of a bridging clutch 82. An outer plate carrier 84 is permanently connected to the housing 12. Inner plates and outer plates, which are connected nonrotatably to the two associated plate carriers 80, 8-4, can be pressed against each other by a clutch piston 86, so that torque can be transmitted directly between the housing 12 and the connecting element 78. When the bridging clutch is engaged, this torque is then transmitted via the primary side 74 of the radially outer torsional vibration damper 28, that is, via the central disk element 72 and damping element units 140, to the cover disk elements 32, 34, which provide the secondary side 70. These in turn transmit the torque onward, namely, in their function as the primary side 30 of the radially inner torsional vibration damper 26, via the damping element arrangement 44 and the central disk element 40 providing the secondary side 38 of the radially inner torsional vibration damper 26, to the turbine wheel hub 25.

When the bridging clutch 82 is released, that is, during operation in torque-conversion mode, in which torque is transmitted by fluid circulation from the pump wheel 16 to the turbine wheel 18, the flow of torque proceeds from the turbine wheel 18, that is, via the turbine wheel shell 22, to the cover disk elements 32, 34, which are permanently connected to it by the rivets 36 and which provide the primary side 30 of the radially inner torsional vibration damper 26. From these cover disk elements, the torque is transmitted via the damping element arrangement 44 and the central disk element 40, i.e., the secondary side 38 of the torsional vibration damper 26, to the turbine wheel hub 25. This means that, during operation in torque-conversion mode, the radially outer torsional vibration damper 28 fulfills essentially no vibration-damping function; on the contrary, it cooperates with the permanently connected components of the bridging clutch 84 to increase the inertia of the primary side 30 of the radially inner torsional vibration damper 26.

A problem with these types of torsional vibration dampers is that, during operation in rotational mode, not only the compressive forces acting in the circumferential direction but also centrifugal forces exert load on the damping element units. Both the circumferential compressive forces and the centrifugal forces lead to forces which act comparatively strongly on the damping element units 46, especially on their central circumferential areas, in the radially outward direction. This means that, especially in the case of the radially inner torsional vibration damper 26 shown in FIG. 2, the two cover disk elements 32, 34 are subjected to heavy loads in the support areas 60, 62 which radially support the damping element units 46. Because of the conformity to the circumferential contour of the damping element units 46, not only a radially outward-directed load but also force components acting in the axial direction are developed, which try to press the cover disk elements 32, 34, which are usually made of sheet metal, away from each other in the direction parallel to the axis of rotation A. This can be lead to radial displacements of the damping element units 46, resulting in a significant increase in the frictional forces and to undefined radial positionings. The rivets 68, which are not designed in and of themselves to absorb heavy loads and which especially are not designed to absorb tipping moments, can be heavily stressed or overloaded and thus damaged by the forces trying to press the cover disk elements 32, 34 axially away from each other.

### SUMMARY OF THE INVENTION

An object of the present invention is to provide a torsional vibration damper in which the forces acting on the damping element units do not produce any operating problems generated by axial forces.

According to a first aspect of the present invention, the radial support arrangement includes a radial support surface for each damping element unit, this surface extending essentially without curvature in the axial direction.

By designing the radial support arrangement so that a radial support extends in the axial direction essentially without curvature, that is, with an essentially cylindrical contour, the forces which are generated by the damping element unit as it is being forced radially outward and which are then transmitted to the radial support surface are not deflected in the axial direction. This means that only radial forces are exerted on the radial support arrangement, so that the axial spreading-apart of the various components and excessive axial loads can be avoided.

In an embodiment which can be realized with an especially simple design, each of the cover disk elements provides a part of the radial support surface.

It is possible, for example, for the parts of the radial support surface provided by the two cover disk elements to be adjacent to each other in the axial direction. To ensure simultaneously that the damping element units are held in the damping element openings and cannot escape in the axial direction, an axial support area can be provided on at least one of the cover disk elements, adjacent to the part of the radial support surface provided by that element.

In an alternative embodiment, the parts of the radial support surface provided by the two cover disk elements can be arranged so that they follow each other in the circumferential direction. To ensure a defined axial retaining element function in this case as well, one of the cover disk elements provide an axial support area in the circumferential area where the other cover disk elements can provide a part of the radial support surface.

According to a second aspect of the present invention, the radial support arrangement includes a radial support element which extends circumferentially around the axis of rotation preferably in a ring-like manner and is not permanently connected to the two cover disk elements.

By providing an independent, preferably ring-like radial support element, it is possible to avoid the introduction of radial forces into the cover disk elements and therefore to prevent excessive loads on them.

The radial support element can be designed so that it has a support surface with certain areas which conform to the circumferential contour of the damping element units.

It is also possible for the radial support element to comprise two support element parts, each of which provides part of the support surface and which rest against each other. For example, the radial support element can form a central disk element or a cover disk element of another torsional vibration damper.

According to another aspect of the present invention, the radial support arrangement includes at least one radial support element with a support surface provided on a single component and which has at least certain areas which conform to the circumferential contour of the damping element units.

By designing a radial support surface with a geometry conforming to the circumferential contour of the damping element unit, i.e., in general to a curved geometry, on a single component, the danger that spreading could occur under the action of radial forces deflected in the axial direction is virtually eliminated.

For example, one of the cover disk elements can provide the radial support element for all of the damping element units. The cover disk element can project radially outward over the damping element units and then be permanently connected to the other cover disk element to ensure stabilization in the axial direction as well.

In an alternative variant, to provide the support surface, a radial support element can be assigned to each damping element unit, this radial support element being located in the associated damping element openings in the cover disk elements and in the central disk element.

According to another aspect of the present invention, in the case of at least one cover disk element, the radial support arrangement at the damping element opening includes a support area with a support surface with at least certain areas which conform to the circumferential contour of the damping element units, and a stiffening area between at least two damping element openings adjacent to each other in the circumferential direction.

The stiffening area may include a stiffening rib, which extends essentially in the radial direction and which is produced by a metal-forming operation.

According to another aspect of the present invention, at least in the case of one cover disk element, the radial support arrangement at the damping element opening includes a support area with a support surface with at least certain areas which conform to the circumferential contour of the damping element units, at least one circumferential end area of the damping element unit can be supported by a support element on the support areas of the cover disk elements and of the central disk elements; and the support elements have axial retaining projections, which extend over the surfaces of the cover disk elements which face away from each other.

Because the cover disk elements are held together axially by the support elements, it can be ensured that even forces which act on the cover disk elements in the axial direction and thus try to push them away from each other cannot cause the disks to spread apart.

It is also possible for the support elements to have radial retaining projections, which prevent the end areas of the damping element units being supported by them from moving radially outward.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows a partial longitudinal cross section through a hydrodynamic torque converter according to the prior art with two torsional vibration dampers;

FIG. 2 shows an enlarged detail view of the radially inner torsional vibration damper of the torsional vibration damper arrangement of FIG. 1;

FIG. 3 shows a radially inner torsional vibration damper according to the invention;

FIG. 4 shows a partial circumferential cross section through another torsional vibration damper according to the invention;

FIG. 5 shows the torsional vibration damper of FIG. 4 in a cross section along line V-V of FIG. 4;

FIG. 6 shows the torsional vibration damper of FIG. 4 in a cross section along line VI-VI of FIG. 4;

FIG. 7 shows another radially inner torsional vibration damper according to the invention;

FIG. 8 shows another radially inner torsional vibration damper according to the invention;

FIG. 9 shows another radially inner torsional vibration damper according to the invention;

FIG. 10 shows a circumferential cross section through the torsional vibration damper of FIG. 9 along line X-X of FIG. 9;

FIG. 11 shows a view, corresponding to FIG. 2, of a torsional vibration damper according to the invention with two radially offset torsional vibration dampers;

FIG. 12 shows a partial view of the detail inside circle XII in FIG. 11;

FIG. 13 shows a partial axial view of a cover disk element designed according to the invention;

FIG. 14 shows a partial axial view of a torsional vibration damper according to the invention, presented here in the form of a clutch disk;

FIG. 15 shows a cross-sectional view of the torsional vibration damper of FIG. 14 along line XV-XV of FIG. 14;

FIG. 16 shows a circumferential cross section through the torsional vibration damper of FIG. 14 along line XVI-XVI;

FIG. 17 shows a view of a detail of a modified embodiment of the torsional vibration damper shown in FIGS. 14-16; and

FIG. 18 shows a view, corresponding to FIG. 17, of another modification.

### DETAILED DESCRIPTION OF THE PRESENTLY PREFERRED EMBODIMENTS

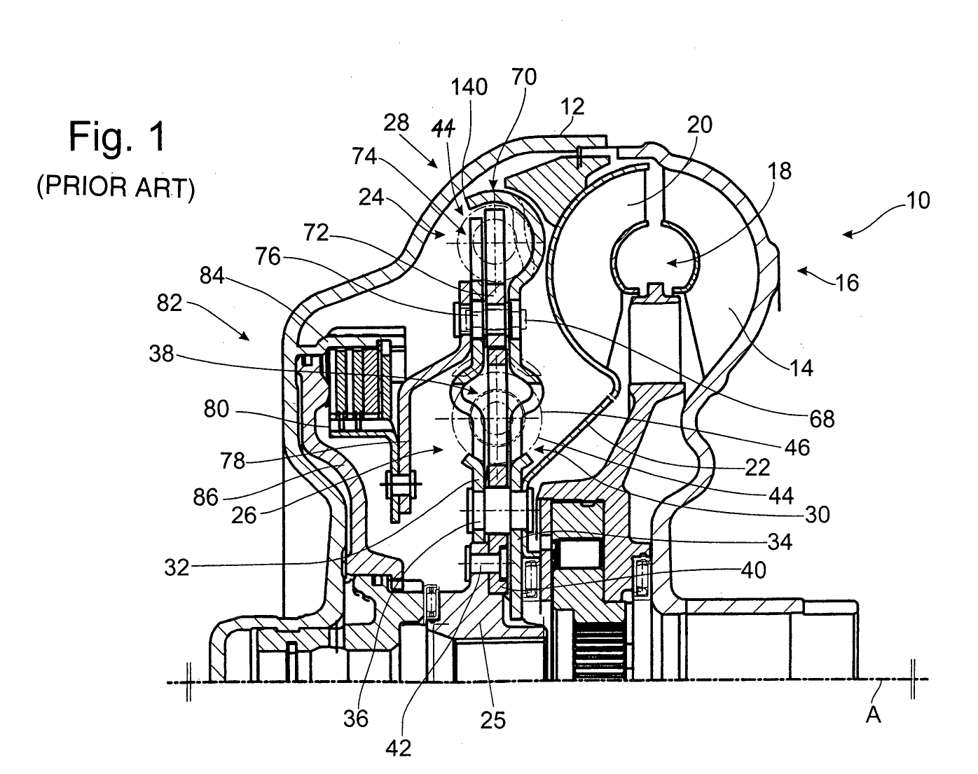

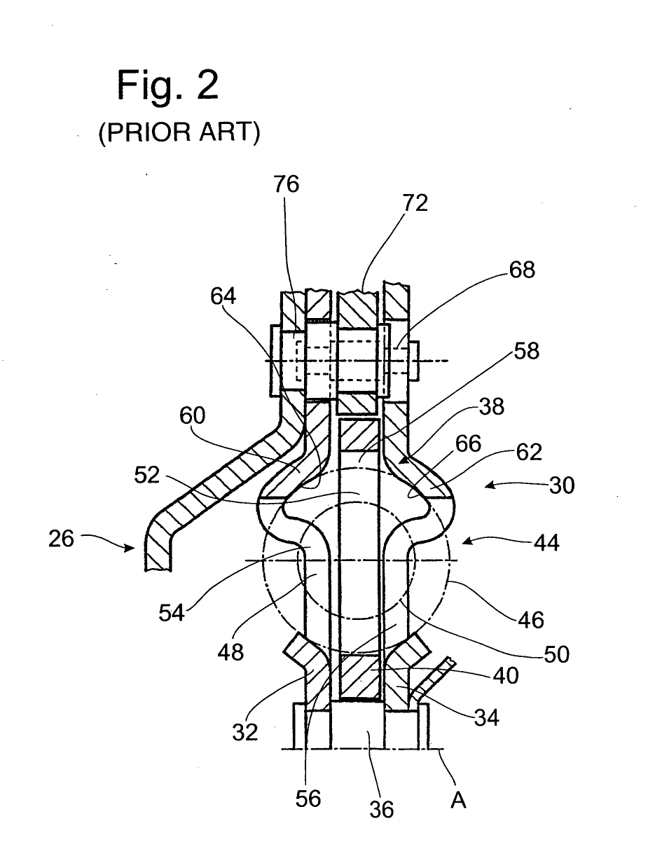

In the following, various embodiments of torsional vibration dampers designed according to the invention are described, which can be integrated, for example, into the torsional vibration damper arrangement 24 shown in FIG. 1 in conjunction with a hydrodynamic torque converter 10. Thus, in the following, the same reference numbers are used for the same assemblies, a suffix being added to characterize the specific embodiment in question. It should be pointed out, however, that the various torsional vibration dampers described below can also be provided in other types of systems such as dual-mass flywheels, clutch disks, etc.

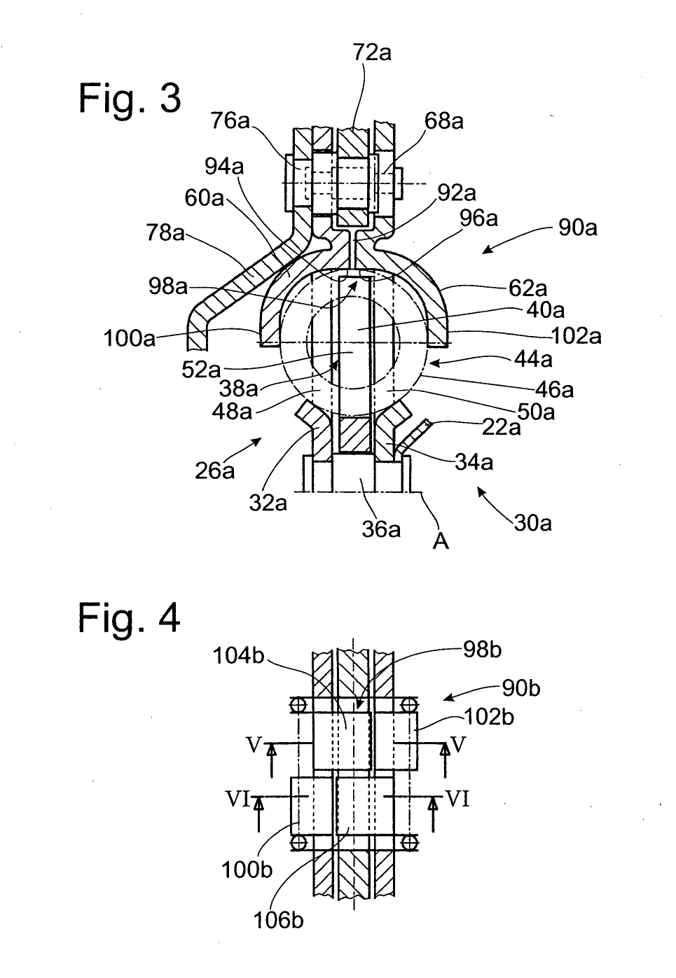

FIG. 3 shows a torsional vibration damper 26a, in which, for example, the two cover disk elements 32a, 34a can provide the primary side 30a, whereas the central disk element 40a provides essentially the secondary side 38a.

The support sections 60a, 62a of the cover disk elements 32a, 34a located radially outside the damping element openings 48a, 50a form a radial support arrangement 90a. It can be seen that, radially inside the connection created by the rivets 68a, the two cover disk elements 32a, 34a curve initially toward each other, so that only a comparatively small gap-like axial intermediate space is present. Proceeding from this gap-like intermediate space 92a, parts 94a, 96a of the two cover disk elements 32a, 34a extend outward to form a radial support surface 98a. This radial support surface 98a follows the shape of the spring windows 48a, 50a as it extends in the circumferential direction around the axis of rotation A, but it does not curve in the axial direction. That is, it has an approximately cylindrical shape, extending in the axial direction parallel to the axis of rotation A. Thus, in the area where the radially outer side of the associated damping element unit 46a is supported on this radially outer support surface 98a, the radial support surface basically does not conform to the generally circular circumferential contour of the damping element units 46a, as can also be seen in FIG. 3, where “circumferential contour” refers to the circumference around the longitudinal axis of the damping element unit 46a and therefore to, for example, the longitudinal axis of a helical compression spring 46a.

As a result of the essentially cylindrical shape of the radial support surface 98a, i.e., a shape which does not curve in the axial direction, the radially outward-directed forces transmitted by the associated damping element unit 46a do not generate any axial components, which means that the two cover disk elements 32a, 34a are subjected to essentially no loads acting in the axial direction. To ensure in addition that the damping element units 46a are also secured axially in position or centered, the support areas 60a, 62a extend around the damping element units 46a to form axial support areas 100a, 102a on both axial sides.

So that, in the variant shown in FIG. 3, the areas of the cover disk elements 32a, 34a in which the associated parts 94a, 96a of the radial support surface 98a extend in the axial direction from the gap-like intermediate space 92a can be prevented from cutting into the outside circumference of the damping element units 46a, the damping element units 46a can be flattened in the circumferential area which rests on the radial support surface 98a.

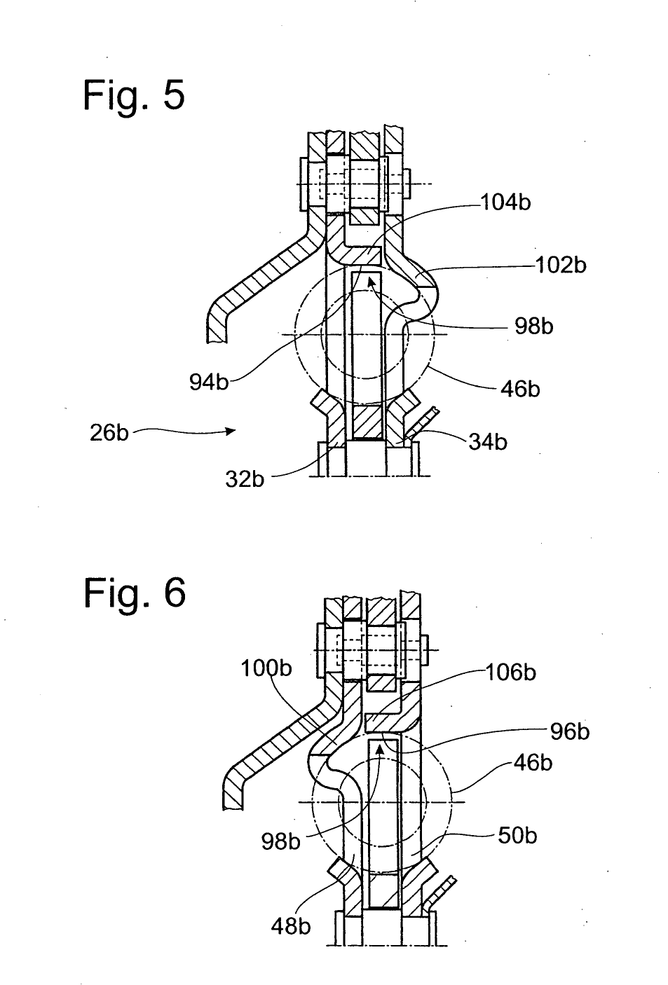

FIGS. 4-6 show a modified embodiment, in which this radial support surface 98b, also with a shape with essentially no curvature in the axial direction, is again provided by the cover disk elements 32b, 34b. It can be seen that, for each damping element unit 46b, each of the cover disk elements 32b, 34b has, radially on the outside, a radial support part 104b, 106b, which curves toward the other cover disk element. The inside circumference of the part 104b provides the part 94b of the radial support surface 98b, whereas inside circumference of the part 106b provides the part 96b of the radial support surface 98b. Whereas these two parts are axially adjacent to each other in the embodiment of FIG. 3, they are circumferentially adjacent to each other, i.e., follow one another in the circumferential direction, in the embodiment of FIGS. 4-6.

It can also be seen that, at each point where one of the cover disk elements 32b, 34b has a radial support part 104b, 106b, that is, where it is bent toward the other cover disk element, the other cover disk element has an axial support part 100b, 102b, which projects partially over the associated damping element unit 46b in the radially inward direction and thus secures it in place in the axial direction. For each set of damping element openings 48b, 50b, therefore, two of these axial support parts 100b, 102b are provided, each of which acts on one axial side of the damping element unit 46b.

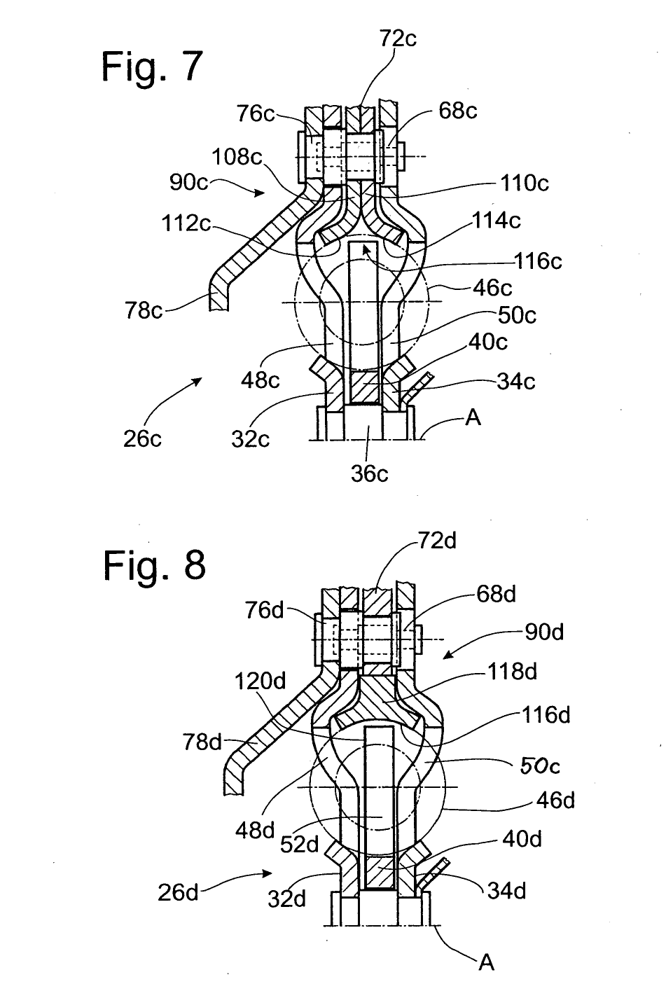

FIG. 7 shows another embodiment of an inventive inner torsional vibration damper 26c. We can see here the central disk element 72c of the radially outer vibration damper (28 in FIG. 1), the rest of which is not shown. The central disk element 72c is made up here of two disk parts 108c, 110c, directly adjacent to each other in the axial direction. These two disk parts 108c, 110c are connected permanently together by the rivets 76c and are also connected to the connecting element 78c.

The two disk parts 108c, 110c are bent away from each other in the axial direction at least in the area of the damping element openings 48c, 50c and thus provide the two parts 112c, 114c of a support surface 116c for the associated damping element unit 46c. These parts 112c, 114c of the support surface 116c formed by the disk parts 108c, 110c can conform to the circumferential contour of the damping element units 46c; that is, they can be slightly concave, so that they can rest flat on the damping element units.

During operation in rotational mode and under the effect of torque, the damping element units 46c come to rest in the radially outward direction against these support surfaces 116c. Because the central disk element 72c, with its two disk parts 108c, 110c, is basically to be considered an independent component, separate from the cover disk elements 32c, 34c, the radial and also possibly axial forces which develop are not transmitted to the cover disk elements 32c, 34c. This means that the axial forces possibly arising as a result of the shape of the disk parts 108c 110c exert load only on the rivets 76c, which connect the two disk parts 108c 110c permanently together. These rivets, however, are much more massive than the rivets 68c and can thus withstand greater loads. It can also be seen that the two disk parts 108c 110c rest directly against each other and are held together in that position by rivets 76c, so that tipping moments, such as those which can develop when axial loads act on the rivets 68c, do not occur.

Another advantage of this design variant is that the radially inner areas of ring-like disk parts 108c, 110c provide symmetric design around the axis of rotation A, so that the radial forces which develop when torque is being transmitted and centrifugal forces are also uniformly distributed around the axis of rotation A, with the result that these radial forces are absorbed completely within the radial support arrangement, i.e., within the central disk element 72c acting as the radial support element, and none of the other assemblies is subjected to load.

FIG. 8 shows a modification with a ring-like radial support element. This radial support element 118d of the radial support arrangement 90d is an independent component, made, for example, of plastic, which lies radially inside the central disk element 72d of the radially outer torsional vibration damper. On its inside circumferential area, at least where a damping element unit 46d is located, this ring-like radial support element 118d has a support surface 116d, which is concave in the axial direction; that is, it conforms to the circumferential contour of the damping element units 46d and thus projects slightly in the axial direction over them and thus holds them axially in place. Any axial loads which may occur during operation in rotational mode are therefore absorbed within one and the same component and cannot lead to spreading loads. Because here, too, the radial support element 118d is in the form of a closed ring, the radial forces transmitted by the damping element units 46d, which are distributed circumferentially and symmetrically around the axis of rotation A, do not affect any of the other assemblies. At the same time, this radial support element 118d can support itself in the radially outward direction on the inside circumference of the central disk element 72d. It can also be seen that the radial support element 118d is guided and/or centered in the axial direction between the two cover disk elements 32d, 34d, so that it is impossible for it to escape in the axial direction.

In this embodiment, it is also possible, for example, for the central disk element 40d of the torsional vibration damper 26d to extend farther out in the radial direction and for the radially outward-projecting sections 120d of the disk element which lie between the associated damping element openings 52d in the disk to be supported radially against the inside surface of the radial support element 118d. Thus the radial support element 118d can also fulfill the function of radially centering the two central disk elements 40d, 72d with respect to each other.

Because of the possibility of producing the radial support element 118d out of low-friction material such as plastic, a very high degree of vibrational decoupling is obtained in the torsional vibration dampers, which is improved even more in particular by the fact that the radial forces exerted by the damping element units 46d of the radially inner torsional vibration damper 26d can be completely absorbed within the ring-like radial support element 118d.

It should be pointed out here that, in principle, it is also possible for the support element 118d to consist of several segments instead of a closed, ring-like element. The segments would be arranged in a row around the circumference and positioned in particular in the area of the damping element openings 48d, 50d, 52d. These radial support elements could then also project over the circumferential ends of the damping element units 46d in the manner of spring plates.

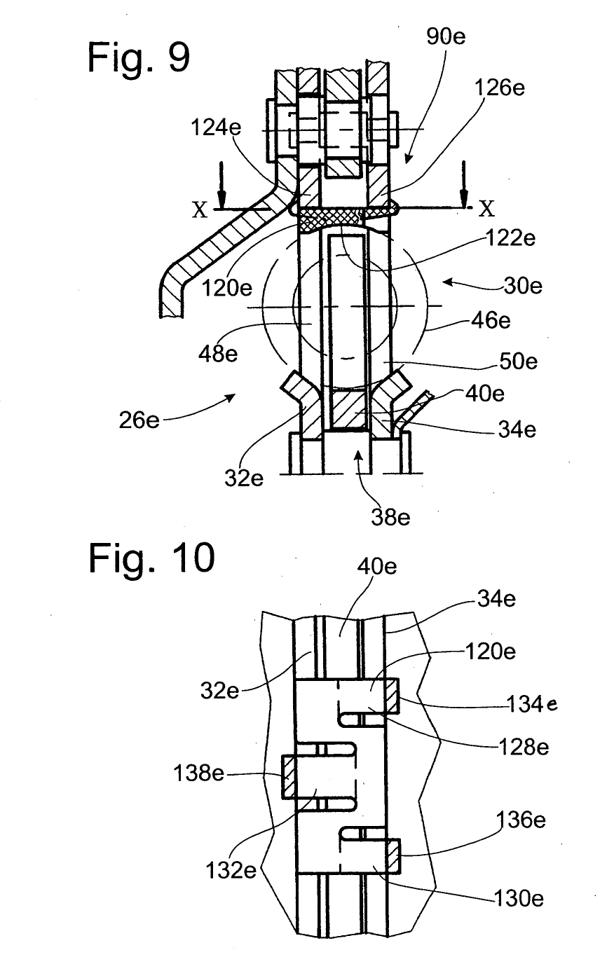

FIGS. 9 and 10 show a design variant in which the radial support arrangement 90e, one of which is assigned to each damping element unit 46e, has a radial support element 120e arranged in the associated damping element openings 48e, 50e of the cover disk elements 32e, 34e. This radial support element has the same length in the circumferential direction as the damping element openings 48e, 50e, for example, so that it cannot shift position in the circumferential direction. Radially on the outside, it rests against the edge areas 124e, 126e of the cover disk elements 32e, 34e, i.e., against the areas which form the boundaries of the damping element openings 48e, 50e. The radial support element or each radial support element 120e has a support surface 122e facing in the radially inward direction with a contour which conforms to the circumferential contour of the damping element units 46e. As can be seen in the plan view of FIG. 10, the radial support element has an undulated shape with two tab-like sections 128e, 130e, projecting toward one axial side and between them a tab-like section 132e projecting toward the other axial side. Each of these tab-like sections 128e, 130e, 132e has a hook-like latching tip 134e, 136e, 138e. These tips project over the axially outside surfaces of the two cover disk elements 32e, 34e, so that the radial support elements 120e are permanently secured in the damping element openings 48e, 50e not only in the circumferential direction but also in the axial direction.

The radial support elements 120e are preferably made of low-friction plastic and, because of their shape and the flexibility of the plastic material, they can be easily introduced into the damping element openings 48e, 50e.

In an alternative embodiment, one or more latching tips, which have radial elasticity because of their tab-like connecting areas, could be provided on one axial side, whereas a fixed, that is, nonelastic, shoulder could be provided on the other side.

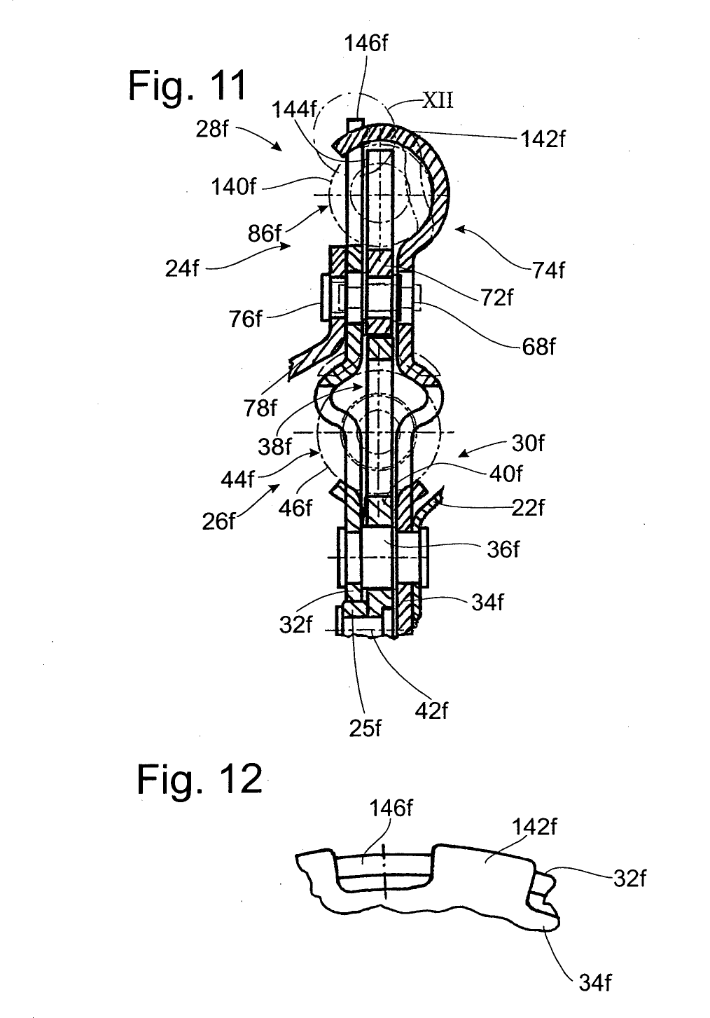

FIGS. 11 and 12 show another embodiment of an inventive torsional vibration damper, here in the form of the radially outer torsional vibration damper 28f of the torsional vibration damper arrangement 24f. It should be pointed out that, of course, the radially inner torsional vibration damper 26f can be designed in any of the ways described above or to be described in the following.

It can be seen in FIG. 11 that, in its radially outer area, that is, the area where it also provides a part of the primary side 74 of the radially outer torsional vibration damper 28f, the cover disk element 34f has tab-like sections 142f, which project over the entire radial dimension of the damping element units 140f of the damping element arrangement 86f and then, for each of the damping element units 140f, form a radial support element with a support surface 144f conforming to the circumferential contour of the damping element units 140f. The sections 142f are drawn around the damping element units 140f so far that they project past the cover disk element 32f located on the other axial side. This other disk element has radially outward-projecting sections 146f, which engage between the sections 142f, as shown in FIG. 12. The sections 146f and the sections 142f can be connected permanently together by welding, rolling, pressing, or by some other suitable method.

When radial loads develop, they are absorbed by the support surface 144f. Because of the permanent connection between the two cover disk elements 32f, 34f radially outside the damping element arrangement 86f of the outer torsional vibration damper 28f, the danger of the radial spreading-apart or of the deformation of the cover disk element 34f, which absorbs the radial load, is eliminated.

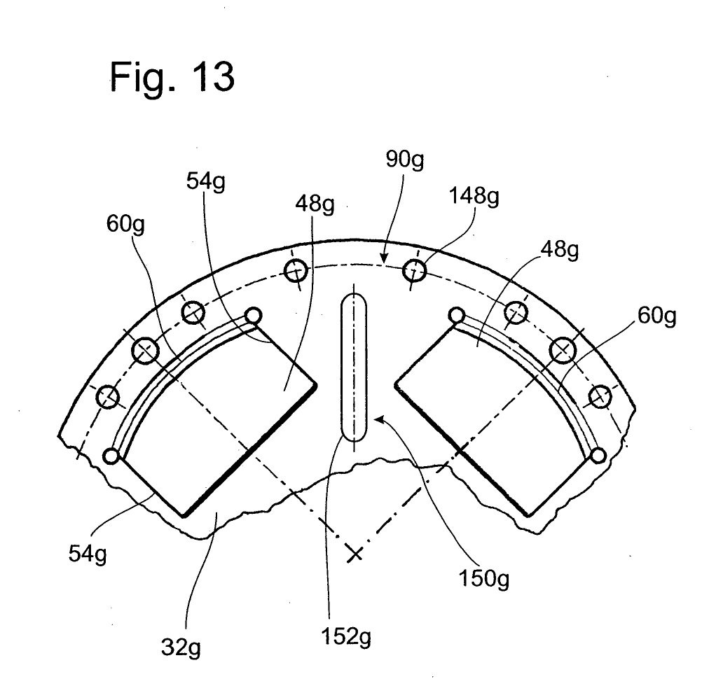

FIG. 13 shows an embodiment of a cover disk element 32g, which can be integrated into any of the previously described torsional vibration dampers but also obviously into any other type of torsional vibration damper which can be installed in, for example, a clutch disk.

The cover disk element 32g has damping element openings 48g, which are bounded in the circumferential direction by the support areas 54g and which, radially on the outside, have the support areas 60g, produced by a forming operation, against which the damping element units are supported in the radially outward direction and also in the axial direction. It is possible to see openings 148g, through which the rivets for connecting the cover disk element 32g to another cover disk element can be guided. So that the deformation of the cover disk element 32g can be prevented as effectively as possible upon the occurrence of radial forces and the corresponding generation of axial loads acting on the areas 60g, the disk has a stiffening area 150g located circumferentially between pairs of damping element openings 48g. This area comprises a more-or-less radially oriented rib-like formation 152g, which is produced by forming of the sheet-metal blank used for the cover disk element 32g. Stiffening the cover disk element 32g in this way significantly reduces the danger of axial deformation even under the action of axial loads.

It is obvious that the stiffening area 150g can also be designed in other ways. Several rib-like formations 152g, possibly also rib-like formations extending in a different directions, can be provided here. Of course, the other cover disk element or both cover disk elements can also be designed in this way.

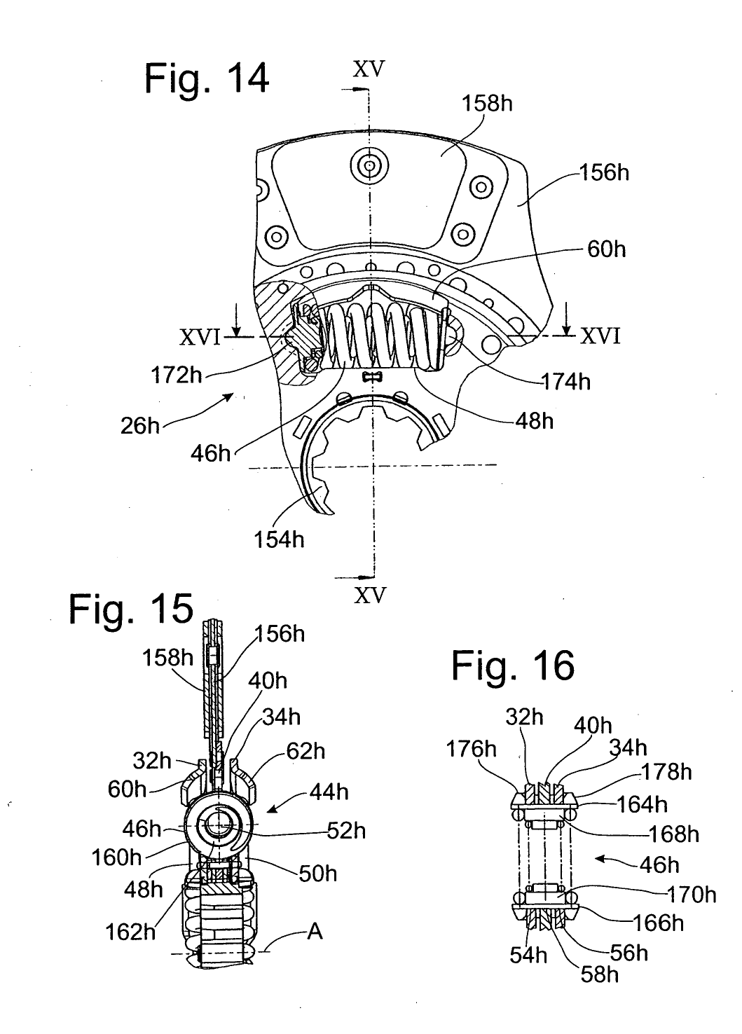

FIGS. 14-16 show a torsional vibration damper 26h, which is provided in a clutch disk of a friction clutch. This torsional vibration damper again comprises two cover disk elements 32h, 34h. These are connected in the radially inner area to a hub 154h for rotation in common around the axis of rotation A. In its radially outer area, the central disk element 40h is connected to a friction lining carrier 156h, which carries the friction linings 158h of the clutch disk. It should be pointed out here that, obviously, the friction lining carrier 156h could also be provided on one of the cover disk elements 32h, 34h.

The damping element openings 48h, 50h, and 52h for the damping element units 46h of the damping element arrangement 44h are again provided in the cover disk elements 32h, 34h, and in the central disk element 40h. The support areas 60h, 62h for the damping element units 44h are again provided in the radially outer area of the damping element openings 48h, 50h in the cover disk elements 32h, 34h.

Basically, therefore, what is shown here is a design in which, upon the occurrence of radial loads, the damping element units 46h, which consist here, as can be easily seen, of two helical compression springs 160h, 162h, one inside the other, subject the support areas 60h, 62h to load in the radially outward direction. Because of the shape of these support areas, axial forces are also generated, which have the tendency to press the cover disk elements 32h, 34h away from each other, especially in the radially outer area.

To counteract this tendency, as FIG. 16 clearly shows, the damping element units 46h are supported by support elements 164h, 166h on the support areas 54h, 56h, 58h, which form the circumferential boundaries of the damping element openings 48h, 50h, 52h. These support elements 164h, 166h, generally referred to also as spring plates, have radial retaining projections 168h, 170h, which fit inside the damping element units 46h, that is, inside the helical compression springs 160h, 162h, so that the support elements 164h, 166h are firmly connected radially to the damping element units 46h. The support elements 164h, 166h are permanently connected to the cover disk elements 32h, 34h or to the central disk element 40h by axially oriented formations 172h, 174h on the support elements 164h, 166h, which engage in corresponding recesses in the cover disk elements 32h, 34h and in the central disk element 40h. Thus it is reliably guaranteed that, when the damping element units 46h are supported on the central disk element 40h or on the cover disk elements 32h, 34h, their circumferential ends cannot move radially outward.

It can also be seen in FIG. 16 that, on the sides cooperating with the cover disk elements 32h, 34h, the support elements 164h, 166h have retaining projections 176h, 178h, which project circumferentially over the outside surfaces of the cover disk elements 32h, 34h, i.e., over the surfaces which face axially away from each other. These projections ensure that the cover disk elements 32h, 34h cannot move axially away from each other when the damping element units 46h exert radial load on the cover disk elements 32h, 34h and the corresponding axial loads develop. Because, under this type of axial load, at least one of the support elements 164h, 166h of the associated damping element unit 46h cooperates with the cover disk elements 32h, 34h, several of these areas at which the cover disk elements 32h, 34h are secured against spreading axially apart are created at various points around the circumference.

To ensure that a support element 164h or 166h of this type which is being supported on the central disk element 40h will return to its associated support areas 54h, 56h on the cover disk elements 32h, 34h as the load imposed by the damping element units 46h starts to decrease and thus to ensure that the axial retaining engagement can be reliably reestablished, the retaining projections 176h, 178h are slanted in the circumferential direction to form guide bevels for the support areas 54h, 56h.

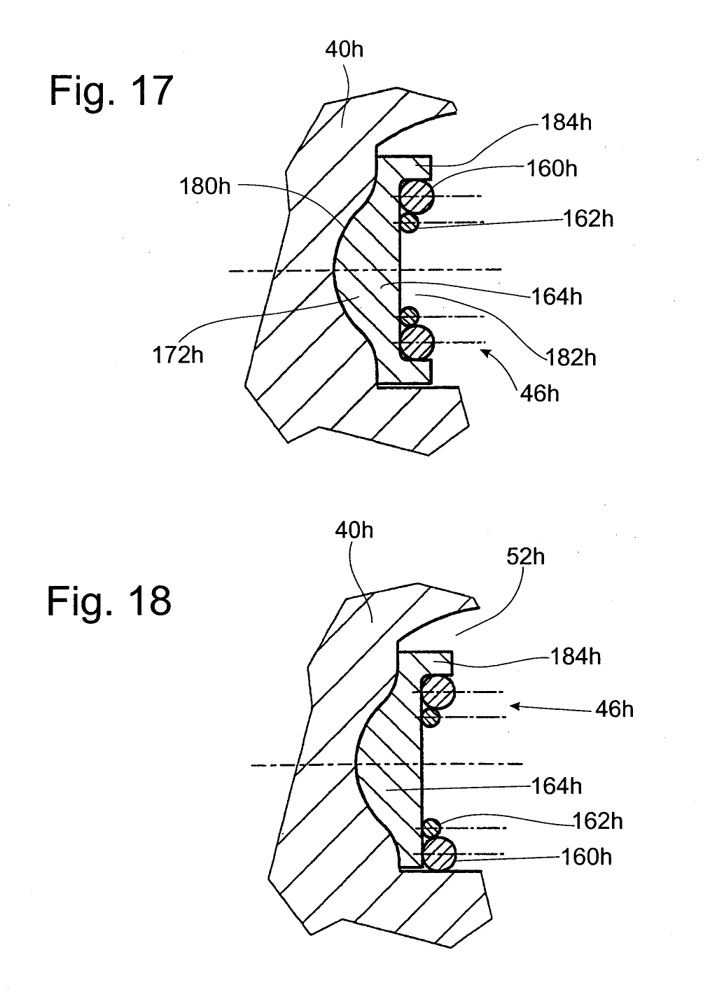

FIGS. 17 and 18 show a modification of the support elements, here illustrated on the basis of one support element 164h, which cooperates in this state with the central disk element 40h. We can see the formation 172h, which engages in the associated recess 180h in the central disk element 140h.

To realize the radial retention of the damping element units 46h on the associated support element 164h, the support element 164h shown in FIG. 17 is designed with a depression 182h conforming to the circumferential contour of the damping element unit 46h. An edge area 184h is therefore provided, which here forms a retaining projection, and which, for example, extends all the way around the end part of the damping element unit 46h. Of course, it is also possible for the edge area 184h to consist only of the radially outer and radial inner areas visible in the figure.

In the case of variant shown in FIG. 18, this type of retaining edge 184h is present only in the radially outer area, so that the radially inner area of the damping element unit 46h can move closer to the inner boundary area of the associated damping element opening 52h.

Many different embodiments of a torsional vibration damper have been described above, which either prevent the possible occurrence of axial loads on the cover disk elements when the damping element units, which extend more-or-less in the circumferential direction and which are generally designed as shaped compression springs, are subjected to load in the radial direction, or guarantee that these types of axial loads cannot cause any excessive deformation of the cover disk elements. It should be pointed out again that the previously described embodiments can be realized in any kind of torsional vibration damper provided with cover disk elements and a central disk element, and that, obviously, the various measures can also be combined with each other in any way desired.

In conclusion, it should be pointed out that, when it was mentioned above that a support surface “conforms” to the circumferential contour of the associated damping element unit, this does not mean that a precise matching of one shape to the other is required. In accordance with the present invention, conformity can also mean that the support surface in question not only supports a damping element unit precisely in the radially outward direction but also generates at least a small supporting effect in the axial direction by extending appropriately around the side of the damping element unit. This combination of radial and axial support can also be realized with a shape which, when considered in the axial direction, is essentially straight but which is angled in the radial direction and thus extends more-or-less at a tangent to the outside circumference of the associated damping element unit. This then, in accordance with the present invention, is also to be understood as “conformity” to the circumferential contour of the damping element unit.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A torsional vibration damper comprising:
a primary side and a secondary side which can rotate about an axis of rotation relative to the primary side, wherein one of said sides comprises a pair of axially spaced cover disk elements which are fixed to each other, each of said cover disk elements having a plurality of circumferentially arranged openings, and the other of said sides comprises a central disk element axially between the cover disk elements, said central disk element having a like plurality of circumferentially arranged openings, each said opening having a pair of circumferential support areas;
a like plurality of damping element units arranged in a circumferential row, said damping element units being arranged in respective circumferentially arranged openings of said cover elements and said central disk element, and being supported against said circumferential support areas; and
a radial support surface supporting each said damping element unit in a radially outward direction, each said radial support surface extending without curvature in the axial direction.

2. The torsional vibration damper of claim 1 wherein each of said radial support surfaces is formed by at least one of said cover disk elements.

3. The torsional vibration damper of claim 2 wherein said cover disk elements provide axially adjacent parts of each said support surface.

4. The torsional vibration damper of claim 3 wherein said cover disk elements has axial support areas which contact respective said damping element units axially.

5. The torsional vibration damper of claim 2 wherein said cover disk elements provide circumferentially adjacent parts of each said radial support surface.

6. The torsional vibration damper arrangement of claim 5 wherein, in circumferential area where one of said parts provides radial support for one of said damping element units, the other of said parts provides axial support for said damping element unit.

7. A torsional vibration damper comprising:
a primary side and a secondary side which can rotate about an axis of rotation relative to the primary side, wherein one of said sides comprises a pair of axially spaced cover disk elements which are fixed to each other, each of said cover disk elements having a plurality of circumferentially arranged openings, and the other of said sides comprises a central disk element axially between the cover disk elements, said central disk element having a like plurality of circumferentially arranged openings, each said opening having a pair of circumferential support areas;
a like plurality of damping element units arranged in a circumferential row, said damping elements unit being arranged in respective circumferentially arranged openings of said cover elements and said central disk element, and being supported against said circumferential support areas; and
a ring-like radial support element extending circumferentially around the axis of rotation and supporting said damping element units in a radially outward direction, wherein said radial support element is not fixed rigidly to either of said cover disk elements.

8. The torsional vibration damper of claim 7 wherein the damping element units have a circumferential contour, said ring-like radial support element having a support surface with areas which conform to the circumferential contour.

9. The torsional vibration damper of claim 8 wherein said ring-like radial support element comprises two support element parts which lie against each other axially, each of said support element parts providing part of said support surface.

10. The torsional vibration damper of claim 7 wherein said ring-like radial support element is a one of a central disk element and a cover disk element of another torsional vibration damper.

11. A torsional vibration damper comprising:
a primary side and a secondary side which can rotate about an axis of rotation relative to the primary side, wherein one of said sides comprises a pair of axially spaced cover disk elements which are fixed to each other, each of said cover disk elements having a plurality of circumferentially arranged openings, and the other of said sides comprises a central disk element axially between the cover disk elements, said central disk element having a like plurality of circumferentially arranged openings, each said opening having a pair of circumferential support areas;
a like plurality of damping element units arranged in a circumferential row, said damping element units having a circumferential contour and being arranged in respective circumferentially arranged openings of said cover elements and said central disk element, and being supported against said circumferential support areas; and
at least one radial support element supporting the damping element units in a radially outward direction and having a support surface formed on a single component, the support surface having areas which conform to the circumferential contour of the damping element units.

12. The torsional vibration damper of claim 11 wherein one of the cover disk elements is formed with the radial support element for all of the damping element units.

13. The torsional vibration damper 12 wherein said one of the cover disk elements projects over the damping element units and is fixed to the other cover disk element.

14. The torsional vibration damper of claim 11 comprising a like plurality of radial support elements in said openings, each said radial support element having a support surface for a respective said damping element unit.

15. The torsional vibration damper of claim 11 wherein the at least one radial support element comprises a plurality radial support surfaces formed on at least one of the cover disk elements at respective said openings, said at least one cover disk element being formed with stiffening ribs between each pair of adjacent said openings.

16. The torsional vibration damper of claim 15 wherein the stiffening ribs are formed in the cover disk and extend essentially radially.

17. The torsional vibration damper of claim 11 further comprising a pair of circumferential support elements seated against the circumferential support areas of each set of openings in the cover disk elements and the central disk element, each support element having a pair of axial retaining projections which extend circumferentially over opposite sides of the cover disk elements.

18. The torsional vibration damper of claim 17 wherein each of the circumferential support elements has a radial retaining projection which extends circumferential over the damping element unit to prevent the damping element unit from moving radially outward.
